(19) United States
(12) Patent Application Publication
(10) Pub. No.: US 2026/0061403 A1
(43) Pub. Date: Mar. 5, 2026

(54) METHOD OF HYDROTREATING FEEDSTOCKS OF BIOLOGICAL ORIGIN

(71) Applicant: Chevron U.S.A. Inc., San Ramon, CA (US)

(72) Inventors: Rong HE, Kensington, CA (US); Yu-Tung TSAI, Richmond, CA (US)

(73) Assignee: Chevron U.S.A. Inc., San Ramon, CA (US)

(21) Appl. No.: 19/312,388

(22) Filed: Aug. 28, 2025

Related U.S. Application Data
(60) Provisional application No. 63/687,953, filed on Aug. 28, 2024.

(51) Int. Cl. B01J 27/19; B01J 21/04; B01J 35/51; B01J 35/61; B01J 35/63; B01J 37/02; C10G 3/00

(52) U.S. Cl. CPC B01J 27/19; B01J 21/04; B01J 35/51; B01J 35/613; B01J 35/615; B01J 35/635; B01J 35/638; B01J 37/0201; C10G 3/46; C10G 3/48; C10G 3/50; C10G 2300/1014; C10G 2300/1018; C10G 2300/4006

(57) ABSTRACT

The present process effectively produces hydrocarbon products upon hydrotreating a feedstock of biological origin. The process comprises first providing a bio feedstock, then passing the feedstock to a reactor comprising a catalyst comprised of about 2 to 6 wt. % Mo, 0.2 to 0.9 wt. % Ni, and 0.05 to 0.50 wt. % P. The bio feedstock is then reacted over the catalyst. The reaction provides good hydrodeoxygenation at a lower reactor temperature than typically required.

### CROSS REFERENCE TO RELATED APPLICATIONS

This application claims priority to U.S. Provisional Application Ser. No. 63/687,953 filed Aug. 28, 2024, the complete disclosure of which is incorporated herein by reference in its entirety.

### TECHNICAL FIELD

The method relates to hydrotreating feedstocks of biological origin to produce renewable fuels. The method employs a specific molybdenum-based catalyst.

### BACKGROUND

Producing renewable fuels from feedstocks of biological origin has specific challenges that are different from traditional hydrotreating. These feedstocks include but are not limited to pyrolysis oil from wood or waste, tall oil pitch, fats, oils, and greases. The degree of unsaturation is often high with these feedstocks and hydrogenating the double bond is part of the reaction steps. These renewable feedstocks often contain high levels of oxygen and require a hydrodeoxygenation reaction that consumes a large amount of hydrogen in producing a hydrocarbon type fuel. Therefore, hydrotreating renewable feedstocks has a high heat release that can be difficult to manage in a commercial scale reactor. It is commonly known that a hydrotreating catalyst of a molybdenum sulfide type with no promoter is the state of the art in this type of application.

U.S. Pat. No. 8,026,401 describes a process where a monometallic molybdenum catalyst produces a partially hydrodeoxygenated stream that is subsequently converted to hydrocarbon over another bimetallic catalyst of a NiMo, CoMo, and NiW type.

U.S. Pat. No. 8,912,375 discloses a process for coprocessing material of biological and fossil origin with a supported unpromoted Mo catalyst having a Mo content of 0.1 to 20 wt. %. The support has a bimodal porous structure with a 2 vol % of total pore volume associated with pores having a diameter larger than 50 nm.

Such Mo only type catalysts presently require the use of an aqueous solution that is stabilized by ammonia in catalyst manufacturing. The manufacturing process releases ammonia which poses a risk to people, process, and the environment. Avoiding such an aqueous solution in catalyst manufacture would be of great benefits.

U.S. Pat. No. 7,560,407 does disclose a catalyst carrier impregnating solution that can be prepared with a Ni to Mo molar ratio of 0.05 to 0.45, and P to Mo molar ratio of 0.05 to 0.25.

A method for hydrotreating renewable, bio feedstocks which can provide good hydrodeoxygenation activity while operating at a lower reactor temperature would be of great benefit to the industry.

### SUMMARY

The present process effectively and efficiently produces products upon hydrotreating a feedstock, starting materials, of biological origin, i.e., a bio feedstock. The process comprises first providing a bio feedstock, then passing the feedstock to a reactor comprising a catalyst comprised of about 2 to 6 wt. % Mo, 0.2 to 0.9 wt. % Ni and 0.05 to 0.5 wt. % P. The remainder of the catalyst comprises a support material. The bio feedstock is then reacted over the catalyst. The present process achieves good hydrodeoxygenation at a lower reactor temperature and provides benefits such as reduced coke formation and extended run lengths.

Among other factors, it has been found that use of the present catalyst with low amounts of molybdenum (Mo), nickel (Ni), and phosphorus (P), good hydrodeoxygenation can be achieved at lower reaction temperatures. Operating at such lower temperatures offers important benefits for commercial reactors. Coke formation is reduced. Pressure drop issues are also mitigated. This all results in extended run lengths. A more efficient and effective process is the result.

### DETAILED DESCRIPTION

As used herein and in the appended claims, singular articles such as “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±15% of the stated value, ±10% of the stated value, ±5% of the stated value, ±3% of the stated value, ±2% of the stated value, or ±1% of the stated value.

The present application relates to a process and catalyst that produces hydrodeoxygenated products from starting materials, feedstocks, of biological origin. The catalyst has a low level of molybdenum, and even lower amounts of nickel and phosphorus. The use of the catalyst in the present process allows the use of a lower reaction temperature, which mitigates issues with coke formation, pressure drop and run length. Despite the lower temperature, good oxygen conversion is still achieved.

Impregnation, such as impregnation by incipient wetness or ion exchange in solution, is a commonly used technique for introducing metals into a catalyst that includes a support. During impregnation, a support is exposed to a solution containing a salt of the metal for impregnation. Multiple exposure steps can optionally be performed to achieve a desired metals loading on a catalyst. For example, catalysts including both molybdenum and nickel can be synthesized by co-impregnation of molybdenum and nickel complexes onto a catalytic support. Optionally, catalysts including both molybdenum and nickel can be formed by sequential impregnation of molybdenum and nickel complexes onto a catalyst support. For example, a catalyst may be prepared by a sequential impregnation where nickel is impregnated first, and then molybdenum is impregnated on the nickel-containing catalyst. Without being bound by any theory, it is believed that sequential impregnation can result in improved distribution of molybdenum (and optionally nickel) on a support After each metal impregnation step in a sequential impregnation process, a metal-impregnated support may be subjected to a drying step by which at least a portion of the volatiles content is driven from the metal-impregnated support but leaving the metals behind upon the surface of the support. The metal-impregnated support particle may be dried under drying conditions that include a drying temperature that is less than a calcination temperature. Typically, the drying temperature will be conducted at a temperature in the range of from 110° C. to 200° C.

The catalyst used in the present process can be prepared by creating a stable impregnating solution comprising an aqueous solution of a molybdenum precursor compound, a nickel precursor compound and a phosphorus precursor component. Any suitable precursor compound for the Mo, Ni, and P can be used as long as the precursors provide the components in the aqueous solution. Examples of molybdenum precursors include molybdenum trioxide, ammonium dimolybdate, and ammonium heptamolybdate. In one embodiment, the precursor compound for Mo is molybdenum trioxide. Examples of nickel precursors include nickel carbonate and nickel nitrate. In one embodiment, the nickel precursor is nickel carbonate. The phosphorus precursor may be an acid or salt, for example phosphoric acid (H₃PO₄), phosphorous acid (H₃PO₃), hypophosphorous acid (H₃PO₂), ammonium dihydrogen phosphate (NH₄H2PO₄), ammonium hydrogen phosphate (NH₄)₂HPO₄. In one embodiment, the phosphorus precursor is phosphoric acid. The component weights can be varied to ensure solution stability, as well as the proper concentration and ratio of metals. Component weights, order of addition, temperature, and reaction times required are well known to those skilled in the art.

Generally, the catalyst described herein can be produced using alternative methods. In an impregnation method (note that pre-and post-impregnation methods are further described below), a powdered porous support material (e.g., an alumina-containing powder such as pseudo-boehmite) is mixed with water and then extruded to form a pelleted catalyst support. The support is dried and calcined, and a Mo metal compound or precursor, a Ni metal compound or precursor and a P compound or precursor are impregnated onto the support. The impregnated wet pellets are then dried and calcined to provide supported catalysts. In another preparation method, a powdered porous support material (e.g., an alumina-containing powder, such as pseudo-boehmite) and catalytic metal precursors, water, and additives such as extrusion aids, peptizing chemicals, and the like, are combined, mixed, and shaped into pellets. The metal-containing wet pellets are then dried and calcined to produce the supported catalyst.

“Pre-impregnated” catalyst refers to a catalyst in which the metals-containing solution or solutions are added before the porous catalyst support is calcined. The metals-containing solution or solutions can be added prior to or after shaping of the catalyst particle, but the important aspect is that the metals-containing solution or solutions be added prior to the support material being calcined. However, there are significant advantages to be gained by shaping of the uncalcined support after impregnation (contact) with an aqueous solution containing one or more catalytic metals. These advantages are observed in the form of more desirable distribution of the metals throughout the support in the final catalyst. Thus, a “pre-impregnated”catalyst can be made as follows:

A powdered uncalcined porous support (e.g., an alumina-containing support such as pseudo-boehmite) is thoroughly mixed with water, or optionally with a dilute aqueous solution of nitric acid, and the mixture is combined with a suitable quantity of a stable metals solution. Such solution typically contains at least one Mo metal compound or precursor and at least one Ni metal compound or precursor, and phosphorus, plus an optional additional quantity of metals solution of one or more metals of Group VIIIB, if required in order to provide the desired amount of metals on the finished catalyst. Note that the one or more metals of Group VIIIB is typically selected to be water-soluble under the temperature conditions encountered. Additionally, a chelating agent or compound can optionally be included in the impregnating solution.

The metal-containing mixture, typically containing about 50 to about 65 wt. % moisture, is shaped into catalyst particles having a desired size and shape, preferably by extrusion. The formed catalyst particles are dried at a temperature of about 110° C. to about 200° C. and then calcined at a temperature of about 500° C. to about 1000° C. for about one to two hours.

“Post-impregnated” catalyst refers to a catalyst in which the metals-containing solution or solutions are added after the porous catalyst support is calcined. Suitable calcining conditions for the support per se are described hereinabove. The porous catalyst support can be calcined before or after shaping of the catalyst support particle, but the important aspect of post-impregnation is that the metals-containing solution or solutions be added after the support material is calcined. Thus, a “post-impregnated” catalyst can be made as follows:

Powdered uncalcined porous support (e.g., alumina-containing support such as pseudo-boehmite) is thoroughly mixed with water, or optionally with a dilute aqueous solution of nitric acid, and the mixture, containing about 50 to 75 wt. % moisture, is then formed into catalyst particles having a desired size and shape, preferably by extrusion. The formed particles are dried at a temperature of about 110° C. to about 200° C. and then calcined at a temperature of about 500° C. to 1000° C. for about one to two hours. The dried and calcined particles are contacted with a suitable quantity of a stable metals solution. For example, such solution typically contains molybdenum, nickel and phosphorus, plus an optional additional quantity of solution of one or more metals of Group VIIIB, if required, in order to provide the desired amount of metals on the finished catalyst, while substantially and uniformly filling the pores. After a suitable contact time, the formed catalyst particles are dried according to one of the alternative conditions described immediately above.

It will be observed that a significant distinction between a pre-impregnated catalyst and a post-impregnated catalyst is that the post-impregnated catalyst undergoes two calcining steps; typically, one consisting essentially of calcining the porous support and the second after which the calcined support has been impregnated with the catalytically active metal components and with a phosphorus component. In contrast, the pre-impregnated catalyst undergoes one calcining step, as described.

The molybdenum will usually be present in an amount of about 2 to about 6 wt. %, alternatively from about 2.2 to about 5 wt. %, or alternatively from about 2.5 to about 4.5 wt. %, calculated as elemental metal and based on the total weight of the catalyst composition. The nickel will usually be present in an amount of from about 0.2 to about 0.9 wt. %, alternatively from about 0.25 to about 0.7 wt. %, or alternatively from about 0.3 to about 0.6 wt. %, calculated as elemental metal and based on the total weight of the catalyst composition. Phosphorus is usually present in an amount of from about 0.05 to about 0.50 wt. %, alternatively from about 0.05 to about 0.30 wt. %, or alternatively from about 0.07 to about 0.20 wt. %, calculated as elemental phosphorus and based on the total weight of the catalyst composition. The amount of molybdenum and nickel metals present in the catalyst composition can be measured using atomic absorption spectrometry (AAS), inductively coupled plasma spectroscopy (ICP) analysis and/or x-ray fluorescence (XRF). The combination of Mo, Ni, and P in such low amounts has been found to be quite effective for the present purposes of hydrodeoxygenation of a bio feed at lower temperatures. Besides the Mo, Ni, and P components, the remainder of the catalyst is generally a support material comprising an alumina.

The catalyst composition may have different shapes selected for their suitability for the process and/or equipment in which they are to be used. For example, if the catalyst composition is to be used in slurry-type reactors, fluidized beds, moving beds (e.g., an on-line catalyst replacement reactor or OCR reactor), or expanded beds (e.g., an upflow reactor or UFR), generally spray-drying or beading is applied. For fixed bed or ebullating bed applications, generally the catalyst composition is extruded, pelletized, and/or beaded. In the latter case, at any stage prior to or during the shaping step, any additives, which are conventionally used to facilitate shaping, can be added. These additives may comprise aluminum stearate, surfactants, graphite, starch, methyl cellulose, bentonite, polyethylene glycols, polyethylene oxides, or mixtures thereof. Further, as discussed elsewhere, when alumina is used as the carrier, nitric acid is sometimes added prior to the shaping step for the purpose of, for example, increasing the mechanical strength of the agglomerates. In the present disclosure, the shaping step is carried out in the presence of water. For extrusion and beading, the amount of water in the shaping mixture, expressed as loss-on-ignition (LOI), preferably is in the range of 20-80%. If required by the shaping operation, additional water can be added or, if the amount of water is too high, it can be reduced by, e.g., solid-liquid separation via, e.g., filtration, decantation, or evaporation. It is within the scope of the skilled person to control the amount of water appropriately.

Suitable shapes include powders, spheres, cylinders, rings, and symmetric or asymmetric polylobal forms, for instance tri-and quadrilobal. Catalysts in the form of pellets or spheres are generally preferred. Average catalyst particles sizes are preferably in the range of from about 0.3 mm to about 6.0 mm, more preferably in the range of from about 0.6 mm to about 5.0 mm.

The specific surface area of the catalyst is not particularly limited. Generally, the specific surface area of the catalyst can range from about 50 to about 300 m²/g; alternatively, from about 90 to about 240 m²/g; or alternatively, from about 120 to about 200 m²/g. The specific surface area is determined by the Brunauer-Emmett-Teller (BET) method according to ASTM D3663. The total pore volume by mercury porosimetry (ASTM D4284) can range from about 0.65 to about 1.20 cm³/g; alternatively, from about 0.75 to about 1.15 cm³/g; or alternatively, from 0.85 to 1.10 cm³/g. The pore volume in pores greater than 250 Å can range from about 0.20 to about 0.60 cm³/g; alternatively, from about 0.25 to about 0.55 cm³/g; or alternatively, from about 0.30 to about 0.50 cm³/g. The pore volume in pores greater than 1000 Å can range from about 0.13 to about 0.40 cm³/g; alternatively, from about 0.15 to about 0.35 cm³/g; or alternatively, from about 0.18 to about 0.32 cm³/g.

The supported catalyst composition following impregnation, drying and calcinations, i.e., wherein the metal-containing components and phosphorus are present as their oxides, and, preferably, prior to a sulfidation step, if any, exhibit the properties described above.

The present technology is also directed to catalyst compositions wherein the metal components have been converted partly or wholly into their sulfides.

Preferably, the catalyst comprises sulfided catalytically active metals. Catalyst metals are often in an oxide state when charged to a reactor and preferably activated by reducing or sulfiding the metal oxide. Hydroprocessing catalysts are generally more active in a sulfided form as compared to an oxide form of the catalyst. A sulfiding procedure is used to transform the catalyst from a calcined oxide state to an active sulfided state. Catalyst may be pre-sulfided or sulfided in situ. Because renewable feedstocks generally have a low sulfur content, a sulfiding agent is often added to the feed to maintain the catalyst in a sulfided form.

As mentioned above, the catalyst may be sulfided in-situ or ex-situ. In-situ sulfiding may be achieved by supplying a sulfur source, usually H₂S or an H₂S precursor (i.e., a compound that easily decomposes into H₂S such as, for example, dimethyl disulfide, di-tert-nonyl polysulfide or di-tert-butyl polysulfide) to the hydroprocessing catalyst during operation of the process. The sulfur source may be supplied with the feed, the hydrogen stream, or separately. An alternative suitable sulfur source is a sulfur-comprising hydrocarbon stream boiling in the diesel or kerosene boiling range that is co-fed with the feedstock. In addition, added sulfur compounds in feed facilitate the control of catalyst stability and may reduce hydrogen consumption.

The bio feedstock includes any suitable bio feedstock. As used herein, a bio feedstock refers to a feedstock from a renewable source. A renewable source may be animal, vegetable, microbial, and/or bio-derived waste materials suitable for the production of fuels, fuel components and/or chemical feedstocks.

One suitable class of bio feedstocks includes lipid compounds. A “lipid” as used herein refers to fats, oils, and greases. Lipids are comprised of saturated and unsaturated fatty acids in the C₈-C₂₄ range, wherein the fatty acids can be in the form of esters of glycerin (i.e., as mono-, di-, and triglycerides), or as free fatty acids (FFA). Exemplary lipid feedstocks include, but are not limited to, an animal fat, animal oil, microbial oil, plant fat, plant oil, vegetable fat, vegetable oil, grease, or a mixture of any two or more thereof. Plant and/or vegetable oils and/or microbial oils include, but are not limited to, corn oil, distiller's corn oil, inedible corn oil, babassu oil, carinata oil, soybean oil, canola oil, coconut oil, rapeseed oil, tall oil, tall oil fatty acid, palm oil, palm oil fatty acid distillate, palm sludge oil, jatropha oil, palm kernel oil, pennycress oil, sunflower oil, castor oil, camelina oil, archaeal oil, bacterial oil, fungal oil, protozoal oil, algal oil, seaweed oil, oils from halophiles, and mixtures of any two or more thereof. These may be classified as crude, degummed, and RBD (refined, bleached, and deodorized) grade, depending on level of pretreatment and residual phosphorus and metals content. However, any of these grades may be used in the present technology. Animal fats and/or oils as used above include, but are not limited to, inedible tallow, edible tallow, technical tallow, floatation tallow, bleachable fancy tallow, lard, technical lard, choice white grease, poultry fat, poultry oils, fish fat, fish oils, and mixtures of any two or more thereof. Greases may include, but are not limited to, yellow grease, brown grease, used cooking oil, restaurant greases, trap grease from municipalities such as water treatment facilities, and spent oils from industrial packaged food operations, and mixtures of any two or more thereof.

For example, in any embodiment, the lipid may include palm oil, canola oil, soybean oil, distillers corn oil, algal oil, poultry fat, tallow, used cooking oil, choice white grease, yellow grease, brown grease, palm sludge oil, fatty acid distillate, or a combination of any two or more thereof.

In embodiments, derivatives of such lipids, such as fatty acid alkyl esters formed via transesterification or esterification of the lipid with an alcohol, may be used. Examples of such fatty acid alkyl esters include fatty acid methyl esters and fatty acid ethyl esters.

Depending on level of pretreatment, the lipid feedstock may contain between about 1 wppm and about 1000 wppm phosphorus, and between about 1 wppm and about 2000 wppm total metals (mainly sodium, potassium, magnesium, calcium, iron, and copper). The lipid may also contain up to about 40 wt. % free fatty acid (FFA). The FFA content of the lipid may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 30 wt. %, about 32 wt. %, about 34 wt. %, about 36 wt. %, about 38 wt. %, about 40 wt. %, or any range including and/or in between any two of these values.

The lipid feedstock contains fatty acid-bound glycerol (or bound glycerol for short) in the form of glycerides (sum of monoglycerides, diglycerides, and triglycerides). The lipid feedstock may contain up to 99.6 wt. % glycerides. The glycerides content of lipid feedstock may be about 20 wt. %, about 30 wt. %, about 40 wt. %, about 50 wt. %, about 60 wt. %, about 70 wt. %, about 90 wt. %, or about 99.6 wt. %, or between any two values within this range. For example, the lipid feedstock may contain a glycerides content in the range of 20 wt. % to 99.6 wt. %, or in the range of 30 wt. % to 80 wt. %.

Another suitable class of bio feedstocks includes liquids derived from biomass liquefaction processes. Examples of such liquefaction processes include (hydro)pyrolysis, solvent liquefaction, hydrothermal liquefaction, torrefaction, catalytic cracking, and combinations thereof. Examples of biomass include, but are not limited to, municipal solid waste, food waste, sewer sludge, manure, forestry residues (e.g., tree thinnings, sawdust, wood chips, etc.), renewable fuel residues, pulp and paper residues (e.g., black liquor), agricultural residues (e.g., corn stover, bean stover, sugar cane bagasse, etc.), herbaceous energy crops (e.g., switchgrass, miscanthus, etc.), woody energy crops (e.g., hybrid poplar, southern yellow pine, etc.), aquatic energy crops (e.g., algae, seaweed, etc.), and mixtures of any two or more thereof. Renewable materials derived from biomass liquefaction processes may be used alone or in combination with lipid feedstocks.

The present technology is most particularly advantageous in the processing of feed streams comprising substantially 100% bio feedstocks. However, in one embodiment of the present technology, bio feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. At a bio feed content in a range of from 1 to 30 wt. %, the petroleum-derived hydrocarbons will generally provide a diluting effect and/or heat sink effect. Accordingly, the present technology is more particularly advantageous for a combined bio and petroleum-derived feedstock comprising a bio feedstock content in a range of from 30 to 99 wt. %, preferably from 40 to 99 wt. %.

In the present technology, the bio feedstock is subjected to hydrotreatment in the presence of hydrogen over sulfided forms of the catalyst described hereinabove. During hydrotreating, a number of different reactions occur, including, for example, hydrogenation, decarboxylation, decarbonylation, and/or hydrodeoxygenation. In hydrogenation reactions, olefinic compounds are saturated by addition of hydrogen. In decarboxylation reactions, oxygen is removed as carbon dioxide. In decarbonylation reactions, oxygen is removed as carbon monoxide. In hydrodeoxygenation reactions, oxygen is removed as water. Cracking reactions can also occur during hydrotreating in which larger molecules (e.g., hydrocarbons) are broken down into shorter-chain molecules.

Generally, the hydrotreating conditions include a pressure of from 500 to 3000 psig (3.45 to 20.68 MPa), and in one embodiment from about 1000 to about 2400 psig (6.89 to 16.55 MPa). The hydrotreating reaction temperature range is typically from 400° F. to 800° F. (204° C. to 427° C.), and in one embodiment from 500° F. to 700° F. (260° C. to 371° C.). For hydrotreating, fixed-bed and/or slurry reactor systems and operating conditions may be used. In some embodiments, continuous reactor systems are used. In some embodiments, continuous fixed-bed reactors are used. In continuous fixed-bed reactor systems, the liquid hourly space velocity (LHSV) is from 0.2 h−1 to 10 h−1, and the hydrogen gas-to-oil ratio is from 200 NL/L to 2000 NL/L. In some embodiments with continuous fixed-bed reactor systems, the LHSV is from 0.5 h−1 to 5.0 h−1. In some embodiments with continuous fixed-bed reactor systems, the hydrogen gas-to-oil ratio is from 400 NL/L to 1600 NL/L.

Hydrotreating is carried out in the presence of hydrogen. A hydrogen stream is, therefore, fed or injected into a vessel or reaction zone or hydroprocessing zone in which the present catalyst is located. Hydrogen, which is contained in a hydrogen containing “treat gas,” is provided to the reaction zone. Treat gas can be either pure hydrogen or a hydrogen-containing gas, which is a gas stream containing hydrogen in an amount that is sufficient for the intended reaction(s), optionally including one or more other gases (e.g., nitrogen and light hydrocarbons such as methane), and which will not adversely interfere with or affect either the reactions or the products. Impurities, such as H₂S and NH₃ are undesirable and would typically be removed from the treat gas before it is conducted to the reactor. The treat gas stream introduced into a reaction stage will preferably contain at least about 50 vol % and more preferably at least about 75 vol % hydrogen.

The hydrotreating reaction step produces an effluent comprising a hydrotreated liquid and a vapor phase comprising hydrogen and by-products of the hydrotreating reaction such as H₂O, CO, CO₂ and light hydrocarbons (typically C₁ to C₃ hydrocarbons). The effluent may be separated into one or more liquid streams and one or more offgas streams.

In a preferred embodiment of the present technology, the process comprises a hydrotreating reaction and an additional reaction selected from a hydroisomerization reaction, a selective hydrocracking reaction and/or a hydrodearomatization reaction. The hydrotreating reaction and the additional reaction(s) may be accomplished in a single stage or multiple stage process. One or more of the hydrotreating reaction and additional reaction(s) may be conducted step-wise and/or simultaneously by selecting the appropriate catalyst(s) and/or operating conditions.

The effluent from the hydrotreating reaction may contain significant amounts of n-paraffins in the C₉ to C₂₄ range. It is preferable to improve the cold flow properties of the liquid product(s) from the process of the present technology by processing at least part of the effluent from the hydrotreating step in a subsequent hydroisomerization reaction. In the hydroisomerization reaction, the stream comprising n-paraffins is contacted with a hydroisomerization catalyst under hydroisomerization conditions to at least isomerize part of the n-paraffins. Hydroisomerization processes and suitable hydroisomerization catalysts are known to the person skilled in the art.

It may also be desirable to selectively crack at least part of the hydrotreating effluent in a selective hydrocracking reaction. In the selective hydrocracking reaction, the stream comprising n-paraffins is contacted with a selective hydrocracking catalyst under hydrocracking conditions to at least crack part of the n-paraffins to molecules with a lower boiling range. Hydrocracking processes and suitable hydrocracking catalysts are known to the person skilled in the art. The selective hydrocracking reaction may be combined with the hydroisomerization reaction and/or the hydrotreating reaction.

The hydroisomerization reaction and/or selective hydrocracking reaction may follow the hydrotreating reaction without any separation step in between the steps.

In another embodiment, the effluent from the hydrotreating reaction is separated into a liquid phase and a gaseous phase. The liquid phase is sent to the additional reaction together with a hydrogen containing gas stream, not being the gaseous phase as obtained directly from the separation from the liquid phase. The liquid phase from hydrotreating reaction may be stripped from dissolved contaminants, such as e.g., CO, CO₂, H₂O, H₂S and NH₃, before being sent to the hydroisomerization step and/or selective hydrocracking step. The hydroisomerization step and/or hydrocracking step may be in co-current mode or in counter-current mode, preferably in co-current mode.

The effluent from one or more hydroprocessing reactions may be sent to fractionation to produce a gasoil boiling point range fraction, a diesel boiling point range fraction, a kerosene boiling point range fraction, a naphtha boiling point range fraction, and combinations thereof, as desired.

The following examples are provided to further illustrate the present catalyst and processes. The examples are not meant to be limiting.

### EXAMPLE 1

### Preparation of Catalyst

An aqueous solution containing 18 wt. % Mo, 2.63 wt. % Ni and 0.57 wt. % P was prepared by heating water, nickel carbonate, phosphoric acid, and molybdenum trioxide to 190° F. and held at this temperature for four hours. An aliquot of this solution (117 g) was mixed with pseudo-boehmite powder (954 g), and nitric acid (5 g), with water (703 g). The wet mixture was extruded into asymmetric quadrilobes of 1/12″ size, followed by drying at 250° F. overnight, and calcination at 1650° F. for 1 hour. The catalyst had the following properties: a surface area of 171 m²/g, a total pore volume of 0.957 cm³/g, a pore volume above 250 Å of 0.32 cm³/g, and a pore volume above 1000 Å of 0.18 cm³/g. The catalyst contained 2.8 wt. % Mo, 0.45 wt. % Ni and 0.096 wt. % P (Ni/Mo molar ratio of 0.26, P/Mo molar ratio of 0.10).

### EXAMPLE 2

### Evaluation of Catalytic Performance

The catalyst from Example 1 was sulfided first and evaluated for hydrodeoxygenation in a feed blend of canola oil with paraffinic solvent having an API of 39.3°and an oxygen level of 3 wt. % at 1680 psig pressure, 1.4 h-1 LHSV, and 10000 SCF/bbl hydrogen to oil ratio to simulate commercial unit operation. The oxygen conversion was 41% at 555° F. with a product API of 41.5°, demonstrating that this catalyst has suitable hydrodeoxygenation activity while keeping the heat release reasonable and preventing coke formation that may lead to excessive pressure drop across a catalyst bed.

A hydrotreating catalyst with 3% Mo was tested under the same pressure, LHSV, and hydrogen to oil ratio as in Example 2. The oxygen conversion was 41% at 580° F. Compared to Example 2, the inventive catalyst can achieve the same oxygen conversion at lower reactor temperature and demonstrate a higher HDO catalytic activity than the reference case. This allows operating at a lower reactor inlet temperature to reduce coke formation, mitigate pressure drop issues, and extend run length.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All publications cited in this disclosure are incorporated by reference herein in their entireties for all purposes.

What is claimed is:

1. A process for hydrotreating a bio feedstock comprising:
providing a bio feedstock;
passing the bio feedstock to a reactor comprising a catalyst comprised of about 2 to 6 wt. % Mo, 0.2 to 0.9 wt. % Ni and 0.05 to 0.5 wt. % P, and
reacting the feedstock over the catalyst.

2. The process of claim 1, wherein the catalyst is comprised of about 2.2 to 5 wt. % Mo, 0.25 to 0.7 wt. % Ni, and 0.05 to 0.30 wt. % P.

3. The process of claim 1, wherein the catalyst is comprised of about 2.5 to 4.5 wt. % Mo, 0.3 to 0.6 wt. % Ni, and 0.07 to 0.20 wt. % P.

4. The process of claim 1, wherein the catalyst components Mo, Ni, and P are impregnated into a porous support.

5. The process of claim 4, wherein the porous support comprises alumina.

6. The process of claim 1, wherein the catalyst has been pre-impregnated, shaped, dried and calcined.

7. The process of claim 1, wherein the catalyst has been post-impregnated, dried and calcined.

8. The process of claim 1, wherein the catalyst is in the shape of pellets or spheres.

9. The process of claim 1, wherein the catalyst has a specific surface area of 50 to 300 m²/g, a total pore volume of 0.65 to 1.20 cm³/g, a pore volume in pores greater than 250 Å of 0.20 to 0.60 cm³/g, and a pore volume in pores greater than 1000 Å of 0.13 to 0.40 cm³/g.

10. The process of claim 1, wherein the bio feedstock is selected from the group consisting of a lipid, liquid derived from a biomass liquefaction process, and a combination thereof.

11. The process of claim 10, wherein the lipid comprises palm oil, canola oil, soybean oil, distillers corn oil, algal oil, poultry fat, tallow, used cooking oil, choice white grease, yellow grease, brown grease, fatty acid distillate, or a combination thereof.

12. The process of claim 10, wherein the lipid has a total glycerides content of from 20 wt. % to 99.6 wt. %.

13. The process of claim 1, wherein the reacting occurs at a reaction temperature in the range of about 400°F. to 800°F. (204°C. to 427°C.).

14. A catalyst useful in hydrotreating bio feedstocks which comprises Mo, Ni, and P and a support material, wherein the catalyst is comprised of about 2 to 6 wt. % Mo, 0.2 to 0.9 wt. % Ni, and 0.05 to 0.50 wt. % P based on the total weight of the catalyst.

15. The catalyst of claim 14, wherein the catalyst is in the shape of pellets or spheres.

16. The catalyst of claim 14, wherein the catalyst has been pre-impregnated, shaped, dried and calcined.

17. The catalyst of claim 14, wherein the support material comprises alumina.

18. The catalyst of claim 14, wherein the catalyst has been post-impregnated, dried and calcined.

19. The catalyst of claim 14, wherein the catalyst has a specific surface area of 50 to 300 m²/g, a total pore volume of 0.65 to 1.20 cm³/g, a pore volume in pores greater than 250 Å of 0.20 to 0.60 cm³/g, and a pore volume in pores greater than 1000 Å of 0.13 to 0.40 cm³/g.
